(19) United States
(12) Patent Application Publication
(10) Pub. No.: US 2025/0129484 A1
(43) Pub. Date: Apr. 24, 2025

(54) ANTI-CORROSION COATING

(71) Applicant: NOF METAL COATINGS EUROPE, Creil (FR)

(72) Inventors: Olivier Valeyre, Boran-sur-Oise (FR); Michael Fayolle, Clairoix (FR); Benoit Millet, Saint-Witz (FR); David Morel, Breuil-le-Vert (FR); Morgane Neuvy, Bailleval (FR); Steven Kerveillant, Maisons-Laffitte (FR)

(21) Appl. No.: 18/720,272

(22) PCT Filed: Dec. 20, 2022
(86) PCT No.: PCT/EP2022/086846

§ 371 Date: Jun. 14, 2024

(30) Foreign Application Priority Data
Dec. 21, 2021 (FR) FR2114189

(51) Int. Cl. C23C 24/10; B22F 1/05; B22F 1/068; B22F 1/107; B22F 1/12

(52) U.S. Cl. CPC C23C 24/103; B22F 1/05; B22F 1/068; B22F 1/107; B22F 1/12; B22F 2301/30; B22F 2302/25; B22F 2304/10

(57) ABSTRACT

The invention relates to the use of a powdered mixture of zinc flake and of zinc oxide Zn/ZnO to increase the value of the coefficient of adhesion of an anti-corrosion coating, characterised in that the zinc flake represents between 60 and 99% of the mixture of zinc flake and zinc oxide, and more particularly between 70 and 95% of the mixture of zinc flake and zinc oxide. The invention also relates to methods for obtaining and applying the anti-corrosion coating, and to the anti-corrosion coating per se and to substrates covered with the coating.

The invention relates to an anti-corrosion coating for metal parts with improved properties, in particular with improved adhesion properties of the substrate after coating.

### TECHNOLOGICAL BACKGROUND

The state of the art knows various anti-corrosion coatings that use active ingredients comprising, for example, chromium, aluminum, zinc, silane or even molybdenum.

Such coatings are disclosed, for example, in the patent documents CN111893468, CN112280040, WO0238686A2, EP3040445, CN105524505.

However, these various coatings have very different surface properties.

In the automotive field, the development of electric cars is burgeoning. A difficulty for the car manufacturers is the increase of the weight of vehicles: a diesel engine weighs ca. 100 kg, while a standard battery for an electric car weighs between 250 and 500 kg, with a few models above one ton. The power consumption of a vehicle is correlated with its weight: for an equivalent distance, an heavy vehicle will need more energy than a lighter one. Thus, there is a need in this field for solutions to reduce the global weight of a vehicle. A possible solution is to reduce the size and the weight of the screws and bolts in the vehicles. It can be assessed that, on a given vehicle, the replacement of all M12 standard-sized screws and of all M12 standard-sized bolts with M8 reference screws and bolts could reduce the global weigh of a vehicle by at least 1 kg. However, using screws and bolts smaller than the standard sizes leads to a weakening of the structure, resulting from a loss of adhesion in the assembly. That's why this solution is not state of the art.

Thus, there is a need for a coating that can be applied onto metal substrates to increase the adhesion between said metal substrates.

There is also a need that this coating gives anti-corrosion properties to the metal substrate.

There is also a need that this coating gives a black appearance to the coated metal substrates.

The purpose of the present invention is a solution with many advantages and improved technical characteristics relatively to the state of the art.

### SUMMARY OF THE INVENTION

The purpose of the present invention also relates to the use of a powdered mixture of zinc flake and zinc oxide, also called “Zn/ZnO powder”, to increase the value of the coefficient of adhesion of an anti-corrosion coating, characterized in that the zinc flake represents between 60 and 99% of the mixture of zinc flake and zinc oxide, and more particularly between 70 and 95% of the mixture of zinc flake and zinc oxide.

The purpose of the present invention also relates to a liquid compound for an anti-corrosion coating, preferably a slurry, characterized in that it comprises:
between 15 and 30% by mass, preferably between 22 and 28% by mass, of Zn;
between 0.5 and 10% by mass, preferably between 8 and 10% by mass, of ZnO;
between 5 and 15% by mass, preferably between 10 and 11% by mass, of a silane binding agent;
between 25 and 50% by mass, preferably between 30 and 40% by mass, of water;
between 10 and 30% by mass, preferably 20% by mass, of at least one organic solvent;
facultatively additives, wherein the percentages are relative to the total mass of the liquid compound.

The purpose of the present invention also relates to a process to manufacture a compound according to the invention comprising the following successive steps:
(a) manufacturing a silane binding agent in water, and
(b) adding and solubilizing the aqueous solution of the step (a) into a solvent-containing solution comprising the Zn/ZnO powder.

The purpose of the present invention also relates to liquid compound for anti-corrosion coating that can be obtained by the manufacturing process comprising the following successive steps:
(a) manufacturing a silane binding agent in water, and
(b) adding and solubilizing the aqueous solution of the step (a) into a solvent-containing solution comprising the Zn/ZnO powder.

The purpose of the present invention also relates to a process to protect a metal substrate against corrosion with an anti-corrosion coating, comprising the following successive steps:
(a1) a step of application of said substrate with a liquid compound according to the invention;
(b1) a step of drying the coated substrate of step (a1); and
(c1) a step of firing the coated substrate of step (b1).

The purpose of the present invention thus relates to a substrate coated with at least one layer of a compound that can be obtained by the process to protect a metal substrate against corrosion with an anti-corrosion coating, comprising the following successive steps:
(a1) a step of application of said substrate with a liquid compound according to the invention;
(b1) a step of drying the coated substrate of step (a1); and
(c1) a step of firing the coated substrate of step (b1).

The purpose of the present invention thus relates to an anti-corrosion coating that can be obtained by drying and then firing of a liquid compound according to the invention, characterized in that the thickness of the coating is between 5 μm and 15 μm, preferably of 8 μm plus or minus 3 μm.

The purpose of the present invention can more specifically relate to a vehicle comprising an anti-corrosion coating according to the invention, in particular at the fixing means, such as bolts, screws, clips, settings, clamps, rivets, etc. and to the items requiring such fixing means, such as assembly plates of said vehicle. Indeed, preferably, the application of a coating onto an assembly plate makes it possible to increase the adhesion of said plate in contact with another plate, whether coated or not with a similar coating, to mitigate the risk of a movement of said coated plate relatively to the other plate.

### Definitions

By “anti-corrosion coating”, it shall be understood in the context of the present invention either a process of anti-corrosion coating or a product for anti-corrosion coating, the product resulting from the process in this context. The purpose of the coating is to improve the anti-corrosion properties of the surface of the treated item. Thus, the obtained coating reduces the alteration of the treated item by chemical reaction with an oxidant.

By “powdered mixture of zinc flake and zinc oxide, also called Zn/ZnO powder”, it shall be understood in the context of the present invention zinc flake particles reinforced with zinc oxides in order to give a darker shade to the zinc powder and to the liquid compound.

In the context of the present invention, the “adhesion coefficient”, also called “coefficient of friction at the interface”, refers to a method for the measurement of a friction coefficient between two coated metal plates. The friction coefficient μ characterizes the friction conditions according to T=μ F, where T is the translation effort required to slide a part on another one, in Newton, and F is the pressure between the parts, in Newton (see FIG. 3 for illustration). Thus, for a given pressure F between two parts, the more effort T is required to apply for a translation, the bigger the friction coefficient.

In the field of automotive and mechanical construction, the coefficient of friction is a key parameter in screwed assemblies, because it links the applied tightening torque and the resulting strain in the screw. In a screwed system, too high a friction coefficient will lead to an under-tightening between the screw and the nut. This phenomenon can be offset by a suitable variation of the coefficient of friction thanks to some lubricant on either or both fixing items. However, too much lubrification will lead to over-tightening, which may lead to a break of the couple when using.

In the context of this invention, the measurement of the friction coefficient is made at the interface between two coated metal plates according to the standard EN1090-2 “Execution of steel structures and aluminum structures—Part 2: Technical requirements for steel structures; Appendix G (EN 1090-2:2008 (F)—Appendix G). The two coated plates are fixes against each other thanks to several fixing items and are submitted to a pressure F. One of the plates is called “fixed plate” while the other plate is called “movable plate”. A translation effort T is applied to the movable plate to observe a movement relative to the fixed plate, and then to figure out the adhesion coefficient μ between the two plates (see FIG. 4). Then, a category is assigned to the surface treatment according to the value of the measured friction coefficient: Category A for μ≥0.50; Category B for 0.40≤μ<0.50; Category C for 0.30≤μ<0.40 and Category D for 0.20≤μ<0.30. Comparatively, the friction coefficient of a steel surface on another steel surface is ca. 0.20, and the friction coefficient of a greased steel surface on a greased steel surface is ca. 0.10. Furthermore, similar standards are being developed in the automotive field, and the purpose of the present invention makes it possible to anticipate these standards.

By “silane”, it shall be understood in the context of the present invention organic compounds comprising at least one silicon atom with at least one Si—C bond. In a silane, the bonds with the silicon atom, in addition to the Si—C bond, are generally Si—O, Si—Si or Si—H bonds, more advantageously Si—O bonds. Advantageously, a silane comprises at least one Si—O function, preferably at least two Si—O functions, more preferably at least three Si—O functions.

By “additives”, it shall be understood in the context of the present invention compounds that allow additional technical effects according to the intended application or objective. Such additives can typically be rheological agents, in particular wetting agents, surfactants, modifiers of pH, salts, superplasticizers, thickeners, pigments, colouring agents, or event additional antioxidants.

By “solvent-containing solution”, it shall be understood in the context of the present invention a solvent(s)-based formulation product.

By “that can be obtained”, it shall be understood in the context of the present invention that the product resulting from the process of the invention can also be obtained by one or several other processes.

If not specified, the percentages are expressed relative to the total mass of the considered composition (or more generally of the product).

### FIGURES

FIG. 1 shows the state of the art with a first plate 1, a second plate 2 linked with each other by a standard screw 3, a standard-sized nut 4A and a facultative washer 4B.

FIG. 2 shows a first plate 5, a second plate 6, both coated with the coating 7 according to the present invention and linked with each other by a less than standard-sized screw 8 and a less than standard-sized nut 9A and a facultative washer 9B.

FIG. 3 shows the implementation of the process of measurement of a friction coefficient. The friction coefficient μ characterizes the friction conditions according to T=u F, where T is the translation effort required to slide a part on another one, in Newton, and F is the pressure between the parts, in Newton.

FIG. 4 shows the implementation of the process of measurement of a friction coefficient, comprising a plate 10 called “fixed plate”, and a plate 11 called “movable plate”. The plates according to the implementation of the measurement process can also be called “test piece”. A translation effort Tis applied to the movable plate 11 to observe a movement relative to the fixed plate 10, and then to figure out the adhesion coefficient μ between the two plates. The fixed plate 10 and the movable plate 11 are held together by fixing means 12 (that allow the translation T anyway).

FIG. 5 shows a view from above of a steel test piece made of C45 E+N (yield point≥430 MPa) with an opening 13 whose diameter can be 13.5 mm corresponding to a M12 fixing according to the standard NF EN 20273. The test piece has a length A and a width B. A and B can be equal, for example equal to 100 mm. The test piece can comprise at least one opening 14 close to an edge of the test piece. Preferably, the test piece comprises 4 openings 14 with diameter(s) less than the diameter of the opening 13. Furthermore, the test piece can have bevelled angles, wherein each bevel is made by retracting values C and D from the lengths A and B, respectively. C and D can be equal, for example equal to 6 mm.

FIG. 6 shows a side view of a steel test piece made of C45 E+N (yield point≥430 MPa) as shown in FIG. 5, wherein said test piece has a thickness E.

FIG. 7 shows the principle of application of effort (traction/compression) of a pair of test pieces 15, 16, made of a static test piece 15 and a movable test piece 16. Compression efforts F1, F2, called perpendicular compression efforts, are applied to this pair of test pieces perpendicularly to the contact zone Z between these two test pieces, while a traction or compression effort T is applied parallel to the plane of this contact zone Z. A load cell 17 makes it possible to observe and/or register compression efforts F1, F2. A support sleeve 18 can possibly be used to hold the two test pieces 15, 16.

### DETAILED DESCRIPTION

Using a powder of zinc and zinc oxide in the context of the present invention, and of the processes, compositions, coated substrates and coatings of the invention has several advantages.

On one hand, the coating of the invention has an intrinsic characteristic of anti-corrosion, which means that it protects the surfaces where it is applied from the chemical reactions with an external oxidant.

On the other hand, the coating of the invention has an excellent adhesion to the support (also called substrate) while providing an adhesion coefficient not less than 0.5. For example, the coating of the invention has an adhesion coefficient not less than 0.6, not less than 0.7.

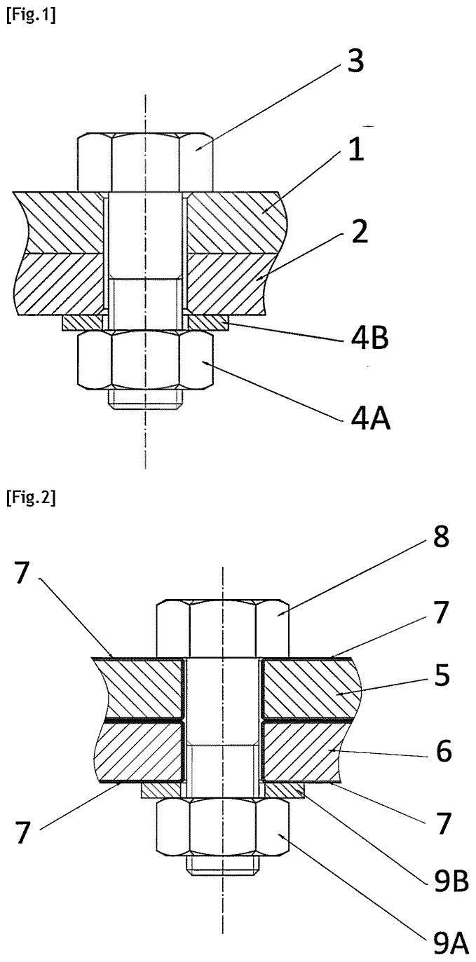

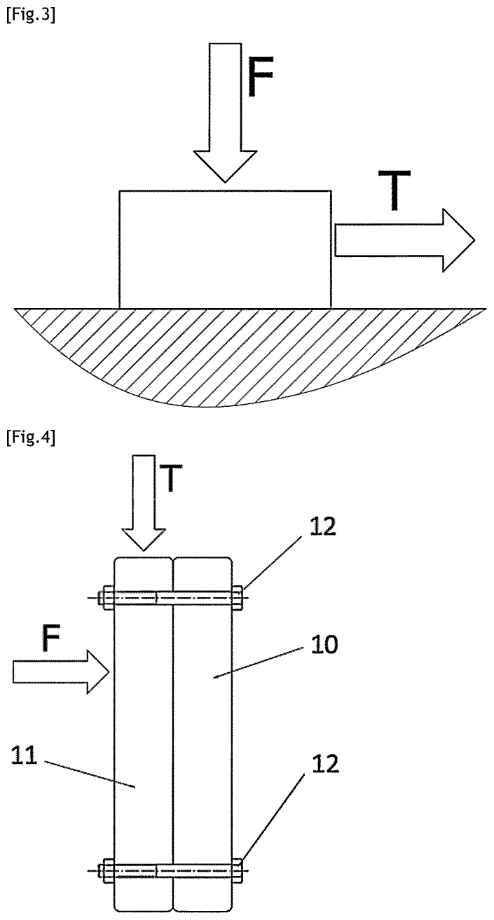

Thus, a technical advantage from this adhesion characteristic is securing assemblies, so a reduction of the dimensions of the fixing devices (for example of the screw/nut sets). In an assembly of two parts held together by one or several fixing means, a low adhesion coefficient between the two parts will lead to movements of the assembled parts, which may, for example, lead to unscrewing of a screwing or, more seriously, to damages to the fixing system. Thus, a high adhesion coefficient between the two assembled part makes it possible to reduce the need for strain at the fixation zones to hold the assembly. This increased adhesion between the plates gives the opportunity to reduce the dimensions of the used fixing means while maintaining the mechanical properties of said fixing means and maintaining the required stability of the assembly. Thus, it may be considered in an assembly the use of smaller size screws and nuts with equivalent classes of steel relatively to the standards, such as, for example, M12-sized screws replaced by M8-sized screws (see FIGS. 1 and 2). This way, the weight and/or the number of fixings is reduced, and when such fixings are used in a vehicle, the total weight of the vehicle is reduced. Thus, reducing the weight implies reducing the fuel consumption, reducing the emission of greenhouse gas (such as CO₂) from the combustion of such fuel, or increasing the speed of the vehicle. However, these classical anti-corrosion protection techniques of the automotive industry, such as cataphoresis, generate coatings with too little adhesion coefficients. The coating of the invention makes it possible to solve this drawback, by giving the coated metal substrate resistance to corrosion and an increased adhesion coefficient.

### Use of Powdered Zinc to Increase the Adhesion Coefficient

The use of the present invention requires a powdered mixture of zinc flake and zinc oxide, also called “Zn/ZnO powder”, wherein said Zn/ZnO powder can be comprised in a liquid compound for an anti-corrosion coating, characterized in that the zinc flake represents between 60 and 99% of the mixture of zinc flake and zinc oxide, and more particularly between 70 and 95% of the mixture.

In a specific embodiment, said anti-corrosion coating of said use according to the invention is the anti-corrosion coating of a substrate. Advantageously, said substrate is a mechanical part.

In a specific embodiment, said substrate is a mechanical part requiring an adhesion coefficient higher than 0.5, preferably not less than 0.6, or not less than 0.7, such as an assembly plate.

In a specific embodiment, said substrate is a metal part that undergoes some friction or designed to undergo some friction.

In a particular embodiment, said substrate is a fixing means, preferably selected in a list consisting in a bolt, a screw, a clip, a setting, a clamp, a rivet, or a fixed item such as a suspension arm.

### Liquid Compound

Thus, one of the purposes of the present invention relates to a liquid compound comprising powdered zinc with a particle size comprised between 1 μm and 40 μm for use in the formulation of a liquid compound for anti-corrosion coating.

Preferentially, the liquid compound for anti-corrosion coating according to the present invention comprises between 22 and 28% by mass of Zn, between 18 and 27% by mass of Zn, between 19 and 26% by mass of Zn, wherein the percentages are relative to the total mass of the compound.

More preferentially, the liquid compound for anti-corrosion coating according to the present invention comprises 25% more or less 4% by mass of Zn, wherein the percentages are relative to the total mass of the compound.

Preferentially, the liquid compound for anti-corrosion coating according to the present invention comprises between 6 and 14% by mass of ZnO, between 7 and 13% by mass of ZnO, between 8 and 12% by mass of ZnO, between 9 and 11% by mass of ZnO, wherein the percentages are relative to the total mass of the compound.

Preferentially, the liquid compound for anti-corrosion coating according to the present invention comprises 8% more or less 3% by mass of ZnO, wherein the percentages are relative to the total mass of the compound.

In an embodiment, the liquid compound for anti-corrosion coating according to the present invention comprises:
between 15 and 30% by mass of Zn, between 22 and 28% by mass of Zn, between 18 and 27% by mass of Zn, between 19 and 26% by mass of Zn, between 20 and 25% by mass of Zn, wherein the percentages are relative to the total mass of the compound; and
between 0.5 and 10% by mass of ZnO, between 1 and 10% by mass of ZnO, between 2 and 10% by mass of ZnO, between 3 and 10% by mass of ZnO, between 4 and 10% by mass of ZnO, between 5 and 10% by mass of ZnO, between 6 and 10% by mass of ZnO, between 7 and 10% by mass of ZnO, between 8 and 10% by mass of ZnO, between 7 and 9% by mass of ZnO, wherein the percentages are relative to the total mass of the compound.

Preferentially, the liquid compound for anti-corrosion coating according to the present invention comprises between 20 and 45% by mass of a mixture Zn/ZnO, between 23 and 42% by mass of a mixture Zn/ZnO, between 25 and 40% by mass of a mixture Zn/ZnO, between 27 and 38% by mass of a mixture Zn/ZnO, between 29 and 36% by mass of a mixture Zn/ZnO, wherein the percentages are relative to the total mass of the compound. Preferentially, the liquid compound for anti-corrosion coating according to the present invention comprises 10% more or less 3% of a silane binding agent (added quantity), wherein the percentages are relative to the total mass of the compound.

Advantageously, the silane binding agent is gamma-glycidoxypropyltrimethoxysilane or gamma-glycidoxypropyltriethoxysilane.

In an embodiment, the liquid compound for anti-corrosion coating can be obtained by:
(a) manufacturing said silane binding agent in water, and
(b) adding and solubilizing the aqueous solution of step (a) into a solvent-containing solution comprising a powdered mixture of zinc flake and zinc oxide Zn/ZnO, preferably wherein the zinc flake represents between 60 and 99% of the mixture of zinc flake and zinc oxide, more particularly between 70 and 95% of the mixture of zinc flake and zinc oxide.

Preferentially, the liquid compound for anti-corrosion coating according to the present invention comprises 31% more or less 5% of water, wherein the percentages are relative to the total mass of the compound.

Preferably, the type of compound according to the invention is mainly aqueous. However, the compound can be enriched by an organic solvent, preferably water-soluble, which makes it possible to increase the solubility of the various components of the aqueous solution.

Preferentially, the liquid compound for anti-corrosion coating according to the present invention comprises 20% more or less 5% of an organic solvent, wherein the percentages are relative to the total mass of the compound.

In an advantageous embodiment of the invention, the compound will call for an organic solvent, for example made of a glycol ether, in particular monopropyleneglycol, diethyleneglycol, triethyleneglycol and dipropyleneglycol.

The purpose of the present invention more specifically relates to a liquid compound for an anti-corrosion coating, characterized in that it comprises:
between 22 and 28% by mass of Zn;
between 7 and 9% by mass of ZnO;
between 5 and 15% by mass, preferably between 10 and 11% by mass, of a silane binding agent;
between 25 and 50% by mass, preferably between 26 and 40% by mass, of water;
between 10 and 30% by mass, preferably 20% by mass, of at least one organic solvent; and
facultatively at least one additive,
   wherein the percentages are relative to the total mass of the compound.

Preferably, the referred additives improve the rheological properties, which makes possible an easier formulation of the compound. As a non-limitative example, an additive can be selected among:
a wetting agent, such as alcoholates of fatty alcohols;
a pH modifier, such as selected among alkaline metal oxides or hydroxides, advantageously lithium and sodium, oxide or hydroxides of metals of the groups IIA and IIB of the periodic table, such as strontium, calcium, barium, magnesium and zinc, or a carbonate or a nitrate of above-mentioned metals;
a phosphate, such as aluminum dihydrogen triphosphate;
a salt, either organic or inorganic, such as alkaline silicates;

a surfactant, such as acrylic copolymers or ethoxylated alcohols;
a thickener, in particular from a cellulose derivative, in particular hydromethylcellulose, hydroxyethylcellulose, hydroxypropylcellulose, hydroxypropylmethylcellulose, xanthan gum, or an associative thickener, such as polyurethane-type or acrylic-type.

In an embodiment, the composition according to the present invention can further comprise between 0.5 and 4% by mass of aluminum dihydrogen triphosphate, wherein the percentages are relative to the total mass of the compound.

Preferably, the composition according to the present invention can comprise 2%+1% by mass of aluminum dihydrogen triphosphate, wherein the percentages are relative to the total mass of the compound. Thus, aluminum dihydrogen triphosphate can act as an anti-corrosion agent.

In an embodiment, the composition according to the present invention can comprise between 0.5 and 4% by mass of a molybdenum salt, in particular of molybdenum oxide MoO₃, wherein the percentages are relative to the total mass of the compound.

Preferably, the composition according to the present invention can comprise 2%+1% by mass of a molybdenum salt, in particular of molybdenum oxide MoO₃ (in particular as introduced in the compound), wherein the percentages are relative to the total mass of the compound.

Thus, molybdenum oxide MoO₃ can act as an anti-corrosion agent.

### Manufacturing Process of the Liquid Compound

The purpose of the present invention also relates to a process to manufacture a compound as described above comprising the following successive steps:

(a) manufacturing a silane binding agent in water, and

(b) adding and solubilizing the aqueous solution of step (a) into a solvent-containing solution comprising a powdered mixture of zinc flake and zinc oxide, also called “Zn/ZnO powder”, preferably wherein the zinc flake represents between 60 and 99% of the mixture of zinc flake and zinc oxide, more particularly between 70 and 95% of the mixture of zinc flake and zinc oxide.

In an embodiment, the process according to the invention can be characterized in that the powdered zinc has a size of particles between 1 μm and 40 μm, between 1 μm and 35 μm, between 1 μm and 30 μm, between 1 μm and 25 μm, between 1 μm and 20 μm, between 1 μm and 15 μm or between 1 μm and 10 μm.

Thus, the purpose of the present invention relates to liquid compound for anti-corrosion coating that can be obtained by the manufacturing process as described in the above-mentioned embodiments.

### Process to Protect a Metal Substrate Against Corrosion

The purpose of the present invention also relates to a process to protect a metal substrate against corrosion by formation of an anti-corrosion coating, comprising the following successive steps:
(a1) a step of application of said substrate with a liquid compound according to the invention;
(b1) a step of drying the coated substrate of step (a1), and
(c1) a step of firing the coated substrate of step (b1).

The drying step (b1) can be made at temperatures between 60° C. and 100° C.

The firing step (c1) can be made at temperatures between 300° C. and 350° C.

Preferably, a cleaning step of the metal substrate can be achieved before the step (a1). The cleaning step consists in plunging the metal substrate into a cleaning solution, preferably an alkaline solution, extracting the metal substrate from said cleaning solution, rinsing and drying said metal substrate.

Thus, the purpose of the present invention relates to a substrate coated with at least one layer of a compound that can be obtained by the process to protect a metal substrate against corrosion as described above.

Advantageously, the coated substrate of the invention can be characterized in that said substrate is a mechanical part requiring an adhesion coefficient not less than 0.5, preferably not less than 0.6, or not less than 0.7, such as an assembly plate.

In a particular embodiment, the coated substrate is a fixing means, such as a bolt, a screw, a clip, a setting, a clamp, a rivet, or a fixed item such as a suspension arm, etc.

Advantageously, the anti-corrosion coating according to the invention is applied onto a part of a fixing means as described above, for example a part designed to come into contact with the fixing means of another part.

Such a contact part can be, for example, the thread of a bolt or a screw.

### Anti-Corrosion Coating

The purpose of the present invention also relates to an anti-corrosion coating that can be obtained by drying and then firing of a liquid compound according to the invention, characterized in that the thickness of the coating is between 5 μm and 15 μm, preferably of 10 μm plus or minus 3 μm.

The drying step can be made at temperatures between 60° C. and 100° C.

The firing step can be made at temperatures between 300° C. and 350° C.

Below are described, as non-limitative examples, ways of executing the present invention with reference to the appended figures, where:

### EXAMPLES

### Example 1: Formula of the «Liquid Compound A» According to the Invention

TABLE 1

| Component | Quantity (% in weight) |
|---|---|
| Zinc powder «Zn/ZnO» (75% Zn/25% ZnO) | 34-36% |
| Deionized water | 32-34% |
| Dipropyleneglycol | 14-16% |
| Silane | 10-12% |
| Additives | 7-9% |

### Example 2: Formula of the «Liquid Compound B» According to the State of the Art

TABLE 2

| Component | Quantity (% in weight) |
|---|---|
| Zinc paste | 31-33% |
| Deionized water | 37-39% |
| Dipropyleneglycol | 10-11% |
| Silane | 8-9% |
| Additives | 11-13% |

### Example 3: Measurement of the Friction Coefficient at the Interface

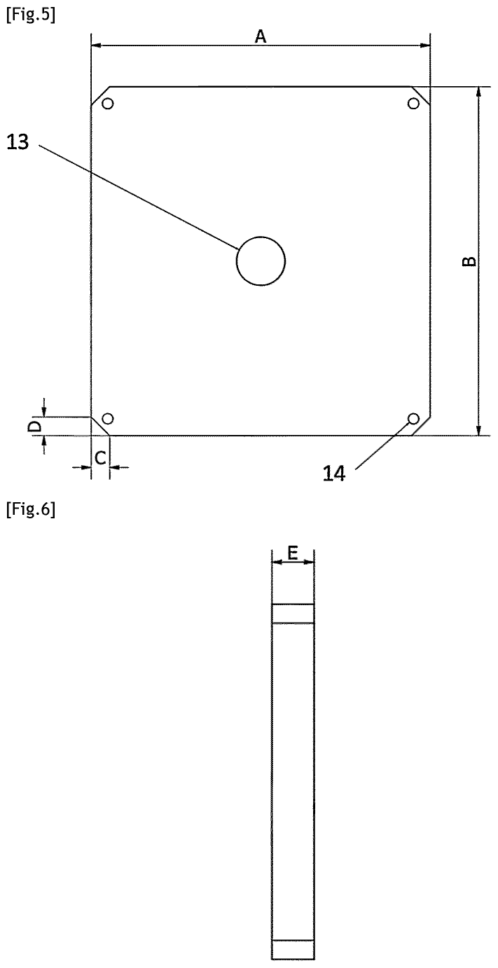

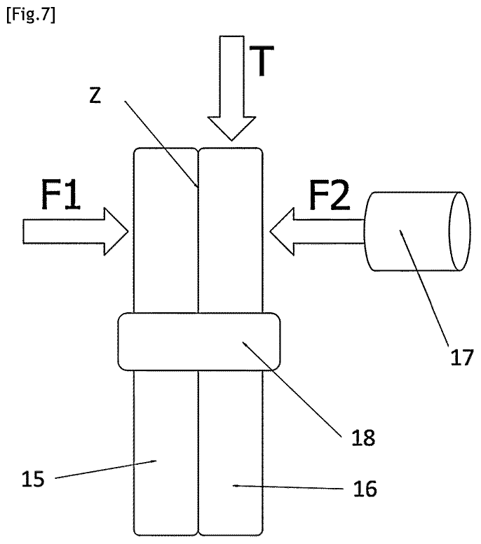

Steel test pieces are made in C45 E+N (yield point≥430 MPa). The 13.5-mm opening diameter corresponds to a M12 fixing according to the standard NF EN 20273 (see FIG. 5). The applied minimal pre-load is 42 500 N.

Three types of test pieces are manufactured (see FIG. 5):
Test piece coated with a solid coating made of the liquid compound B, with a thickness between 7 and 9 μm. The compound B and the process to obtain a solid coating B from the liquid compound B are described in the patent application WO02/38686, table 2.
Test piece coated with a solid coating A made of the liquid compound A, with a thickness between 7 and 9 μm.
Test piece coated by cataphoresis with a thickness between 15 and 20 μm.

The test pieces are sticked against each other with a regulated effort and held with a test bench. One of the test pieces is static while the other test piece is movable. A load is applied onto the movable test piece and the friction coefficient at the interface between the two test pieces is measured (see FIG. 6).

The obtained results are shown in the following table:

TABLE 3

| | | | μ interface |
|---|---|---|---|
| Configuration | Static test piece | Movable test piece | Genuine slide |
| 1 | Cataphoresis | Cataphoresis | 0.064 ± 0.019 |
| 2 | Coating B | Coating B | 0.647 ± 0.029 |
| 3 | Coating A | Coating A | 0.766 ± 0.065 |
| 4 | Coating B | Cataphoresis | 0.423 ± 0.045 |
| 5 | Coating A | Cataphoresis | 0.630 ± 0.051 |

The results show that the configuration 1 has poorer results, with a friction coefficient at the interface of ca. 0.064. As a reminder, the friction coefficient of non-coated steel on non-coated steel is ca. 0.2 according to the literature. Applying a solid coating from the liquid A or B compound onto at least one of the two substrates makes it possible to increase this value above 0.4, as shown by the configurations 2 to 5.

The best results are obtained for a system with a movable test piece coated with a solid coating from the liquid compound A associated with a fixed test piece coated with a solid coating from the liquid compound A.

These results show that using a solid coating according to the invention onto assembly items can lead to systems with high friction coefficients.

1. Use of a powdered mixture of zinc flake and zinc oxide Zn/ZnO to increase the value of the coefficient of adhesion of an anti-corrosion coating, characterized in that the zinc flake represents between 60 and 99% of the mixture of zinc flake and zinc oxide, and more particularly between 70 and 95% of the mixture of zinc flake and zinc oxide.

2. A liquid compound for an anti-corrosion coating, characterized in that it comprises:
between 15 and 30% by mass of Zn;
between 0.5 and 10% by mass of ZnO;
between 5 and 15% by mass of a silane binding agent;
between 25 and 50% by mass of water;
between 10 and 30% by mass of at least one organic solvent;
and facultatively additives;
wherein the percentages are relative to the total mass of the liquid compound.

3. A composition according to claim 2, characterized in that it further comprises between 0.5 and 4% by mass of aluminum dihydrogen triphosphate relative to the total mass of the compound.

4. A process to manufacture a compound according to claim 2 comprising the following successive steps:
(a) manufacturing a silane binding agent in water, and
(b) adding and solubilizing the aqueous solution of step (a) into a solvent-containing solution comprising a powdered mixture of zinc flake and zinc oxide Zn/ZnO, preferably in that the zinc flake represents between 60 and 99% of the mixture of zinc flake and zinc oxide, more particularly between 70 and 95% of the mixture of zinc flake and zinc oxide.

5. A process according to claim 4, characterized in that the powdered zinc has a size of particles between 1 μm and 40 μm.

6. A process to protect a metal substrate against corrosion with an anti-corrosion coating, comprising the following successive steps:
(a1) a step of application of said substrate with a liquid compound according to claim 2;
(b1) a step of drying the coated substrate of step (a1), and
(c1) a step of firing the coated substrate of step (b1).

7. A substrate coated with at least one layer of compound that can be obtained from the process of claim 6.

8. A substrate according to claim 7, characterized in that said substrate is a fixing means, preferably selected in a list consisting in a bolt, a screw, a clip, a setting, a clamp, a rivet, or a fixed item such as a suspension arm.

9. An anti-corrosion coating that can be obtained by drying and then firing of a liquid compound according to claim 2, characterized in that the thickness of the coating is between 5 μm and 15 μm, preferably of 8 μm plus or minus 3 μm.
